(19) United States
(12) Patent Application Publication
(10) Pub. No.: US 2013/0017306 A1
(43) Pub. Date: Jan. 17, 2013

(54) Preformed topping disc for providing a predetermined image on a pizza pie when baked

(71) Applicant: Sergio Maestoso, Fairfield, NJ (US)

(72) Inventor: Sergio Maestoso, Fairfield, NJ (US)

(21) Appl. No.: 13/135,705

(22) Filed: Jul. 13, 2011

(51) Int. Cl. A23C 19/00

(52) U.S. Cl. 426/582

(57) ABSTRACT

A preformed topping disc for providing a predetermined image on a pizza pie when baked, wherein the pizza pie generates vapor and juice when baked. The preformed topping disc includes a preformed cheese disc. The preformed cheese disc contains specifically configured apertures therethrough. The specifically configured apertures in the preformed cheese disc provide the predetermined image on the pizza pie by virtue of the vapor and the juice of the pizza pie oozing through the specifically configured apertures in the preformed cheese disc when the pizza pie is baked. In a first embodiment, the preformed cheese disc is one continuous preformed cheese disc, while in a second embodiment, the preformed cheese disc is made up of multiple individual pieces.

### 1. BACKGROUND OF THE INVENTION

A. Field of the Invention

The embodiments of the present invention relate to a topping for a pizza pie, and more particularly, the embodiments of the present invention relate to a preformed topping disc for providing a predetermined image on a pizza pie when baked.

B. Description of the Prior Art

Numerous innovations for pizza pie-related items have been provided in the prior art, which will be described below in chronological order to show advancement in the art, and which are incorporated herein by reference thereto. Even though these innovations may be suitable for the specific individual purposes to which they address, nevertheless, they differ from the embodiments of the present invention in that they do not teach a preformed topping disc for providing a predetermined image on a pizza pie when baked.

(1) U.S. Pat. No. 4,159,349 to Caiello.

U.S. Pat. No. 4,159,349—issued to Caiello on Jun. 26, 1979 in U.S. class 426 and subclass 94—teaches a cheese topping for a pizza pie, which includes up to four geometrically congruent slices of pizza pie topping cheese. Each of the slices is dimensioned to extend from the center of the pie into the peripheral region of the pie shell, and to extend along a portion of that peripheral region corresponding to the length of that peripheral region divided by the number of the up to four slices. The slices are further dimensioned jointly to cover the food items on the pizza shell, and extend along and into its peripheral region in one layer composed of the slices when contiguously arranged on the food items. Each slice is provided with several apertures through which vapor and juice can rise from the food items on the pizza shell. The apertured slices are contiguously arranged on the food items to form the mentioned one layer covering the food items and extending into the peripheral region of the pie shell.

(2) U.S. Pat. No. 4,293,296 to Caiello et al.

U.S. Pat. No. 4,293,296—issued to Caiello et al. on Oct. 6, 1981 in U.S. class 425 and subclass 547—teaches methods and apparatus for making a, cheese topping for a pizza pie, which uses a mold assembly providing a cavity for receiving a solidifiable fluid mass of topping cheese. The mold cavity has an outline corresponding to at least part of the outline of the peripheral region of the pizza pie. A number of mutually spaced rods are movable relative to the mold cavity. The relatively movable rods are inserted into the mold cavity to provide for apertures in the molded piece of cheese. The rods are withdrawn from the poured cheese, which is removed from the mold after the poured cheese has become sufficiently solidified in the mold to be self-supporting, and contains a number of elongate holes corresponding to the mentioned rods. Slices are cut from the solidified piece of cheese to provide cheese topping slices having apertures through which vapor and juice can rise from the food items on the pizza pie shell during baking of the pie.

(3) U.S. Pat. No. 5,243,899 to Moshier et al.

U.S. Pat. No. 5,243,899—issued to Moshier et al. on Sep. 14, 1993 in U.S. class 99 and subclass 450.1—teaches an apparatus for making a pizza toppings disk. The apparatus includes a conveyor for transporting forming surfaces, and a plurality of depositing apparatuses for depositing onto the forming surfaces a quantity of cheese and a plurality of pizza toppings that may include, but are not limited to, the following items: sliced meats; ground meats; or vegetables; as well as combinations thereof. A fusing apparatus is also included, which fuses the quantity of cheese and the plurality of pizza toppings to form a pizza toppings disk that may be frozen for storage and subsequent use in assembling a pizza.

(4) U.S. Pat. No. 5,256,432to McDonald et al.

U.S. Pat. No. 5,256,432—issued to McDonald et al. on Oct. 26, 1993 in U.S. class 426 and subclass 275—teaches a pizza toppings disk, as well as a method of making a pizza toppings disk and a method of making a pizza using a toppings disk. A pizza toppings disk is made by combining a quantity of cheese with a plurality of pizza toppings that may include, but are not limited, to the following items: sliced meats; ground meats; and vegetables; as well as combinations thereof. The quantity of cheese and selected pizza toppings are combined into a layer that is appropriately shaped to be placed on a pizza shell. The cheese and the selected pizza toppings are fused together to form a pizza toppings disk that may be stored for subsequent use in assembling a pizza. In making a pizza, a pizza toppings disk is placed on a uncooked pizza shell, and the pizza toppings disk and uncooked pizza shell are then baked to produce a cooked pizza.

(5) U.S. Pat. No. 5,894,028 to Alden et al.

U.S. Pat. No. 5,894,028—issued to Alden et al. on Apr. 13, 1999 in U.S. class 426 and subclass 132—teaches a pizza sauce disk and a method for making the disk. The pizza sauce disk includes a pizza sauce that includes a heat-reversible gelling agent. When activated, the gelling agent causes the pizza sauce to at least partially congeal at room temperature or below so that it may be retained in place on a non-edible support surface. Upon further cooling, the pizza sauce forms a more complete gel structure that even after warming to room temperature allows the disk to be handled as a cohesive mass and placed and repositioned on a pizza crust without tearing, breaking, or smearing of the disk. The pizza sauce disk may optionally include cheese and assorted pizza toppings. To form a pizza with the disk, the disk is removed from the support surface and is combined with a pizza crust shell. The pizza may then be cooked and served.

(6) U.S. Pat. No. 6,579,550 to Baur.

U.S. Pat. No. 6,579,550—issued to Baur on Jun. 17, 2003 in U.S. class 426 and subclass 279—teaches a method for producing slices from formable food masses, of which at least one mass is a cheese preparation. A mass is brought into a slice form, in particular, by way of rolls, belts, or plates. After or during the flattening by pressing or a flat application of the mass to a layer of a certain thickness, the mass is applied to specified or unspecified points of the layer or displaced to such an extent that at these points, depressions, holes, and/or free areas occur. Following this, the depressions/holes/free areas are filled out by at least a second mass that differs from the first mass in type/kind, and in particular, in color.

It is apparent that numerous innovations for pizza pie-related items have been provided in the prior art, which are adapted to be used. Furthermore, even though these innovations may be suitable for the specific individual purposes to which they address, however, they would not be suitable for the purposes of the embodiments of the present invention as heretofore described, namely, a preformed topping disc for providing a predetermined image on a pizza pie when baked.

### 2. SUMMARY OF THE INVENTION

Thus, an object of the embodiments of the present invention is to provide a preformed topping disc for providing a predetermined image on a pizza pie when baked, which avoids the disadvantages of the prior art.

Briefly stated, another object of the embodiments of the present invention is to provide a preformed topping disc for providing a predetermined image on a pizza pie when baked, wherein the pizza pie generates vapor and juice when baked. The preformed topping disc includes a preformed cheese disc. The preformed cheese disc contains specifically configured apertures therethrough. The specifically configured apertures in the preformed cheese disc provide the predetermined image on the pizza pie by virtue of the vapor and the juice of the pizza pie oozing through the specifically configured apertures in the preformed cheese disc when the pizza pie is baked. In a first embodiment, the preformed cheese disc is one continuous preformed cheese disc, while in a second embodiment, the preformed cheese disc is made up of multiple individual pieces.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying figures of the drawing.

### 3. BRIEF DESCRIPTION OF THE FIGURES OF THE DRAWING

The figures of the drawing are briefly described as follows:

FIG. 1 is a diagrammatic exploded perspective view of the preformed topping disc of the embodiments of the present invention providing a predetermined image on a pizza pie when baked;

FIG. 2 is a diagrammatic top plan view of a one-piece preformed topping disc of the embodiments of the present invention identified by ARROW 2 in FIG. 1; and

FIG. 3 is a diagrammatic top plan view of a multi-piece preformed topping disc of the embodiments of the present invention identified by ARROW 3 in FIG. 1.

### 4. LIST OF REFERENCE NUMERALS UTILIZED IN THE FIGURES OF THE DRAWING

### A. General

10 preformed topping disc of embodiments of present invention for providing predetermined image 12 on pizza pie 14
12 predetermined image on pizza pie 14
14 pizza pie
16 vapor of pizza pie 14
18 juice of pizza pie 14
20 center of pizza pie 14
22 periphery of pizza pie 14

### B. Configuration of Preformed Topping Disc 10

### (1) First Embodiment

24 preformed cheese disc
26 specifically configured apertures in preformed cheese disc 24 for providing predetermined image 12 on pizza pie 14 by virtue of vapor 16 and juice 18 of pizza pie 14 oozing through specifically configured apertures 26 in preformed cheese disc 24 when pizza pie 14 is baked
28 stars of predetermined image 12 on pizza pie 14
30 one continuous preformed cheese disc of preformed cheese disc 24

### (2) Second Embodiment

32 multiple individual pieces of cheese of preformed cheese disc 24
34 first individual piece of multiple individual pieces 32 of cheese of preformed cheese disc 24
36 first full circle of specifically configured apertures 26 in preformed cheese disc 24
38 first complete lolly pop top of predetermined image 12 on pizza pie 14
40 first half circle of specifically configured apertures 26 in preformed cheese disc 24
42 first half of second complete lolly pop top 44 of predetermined image 12 on pizza pie 14
44 second complete lolly pop top of predetermined image 12 on pizza pie 14
46 second individual piece of multiple individual pieces 32 of cheese of preformed cheese disc 24
48 second half circle of specifically configured apertures 26 in preformed cheese disc 24
50 second half of second complete lolly pop top 44 of predetermined image 12 on pizza pie 14
54 second full circle of specifically configured apertures 26 in preformed cheese disc 24
56 third complete lolly pop top of predetermined image 12 on pizza pie 14
58 third individual piece of multiple individual pieces 32 of cheese of preformed cheese disc 24
60 first complete lolly pop stick of specifically configured apertures 26 in preformed cheese disc 24 of predetermined image 12 on pizza pie 14
62 first complete lolly pop of predetermined image 12 on pizza pie 14
63 first half of second lolly pop stick 64 of specifically configured apertures 26 in preformed cheese disc 24
64 second lolly pop stick of specifically configured apertures 26 in preformed cheese disc 24 of predetermined image 12 on pizza pie 14
66 fourth individual piece of multiple individual pieces 32 of cheese of preformed cheese disc 24
68 second half of second lolly pop stick 64 of specifically configured apertures 26, in preformed cheese disc 24 of predetermined image 12 on pizza pie 14
70 second complete lolly pop of predetermined image 12 on pizza pie 14
72 third complete lolly pop stick of specifically configured apertures 26 in preformed cheese disc 24 of predetermined image 12 on pizza pie 14
74 third complete lolly pop of predetermined image 12 on pizza pie 14

### 5. DETAILED DESCRIPTION OF THE PREFERRED EMBODIMENTS

### A. General

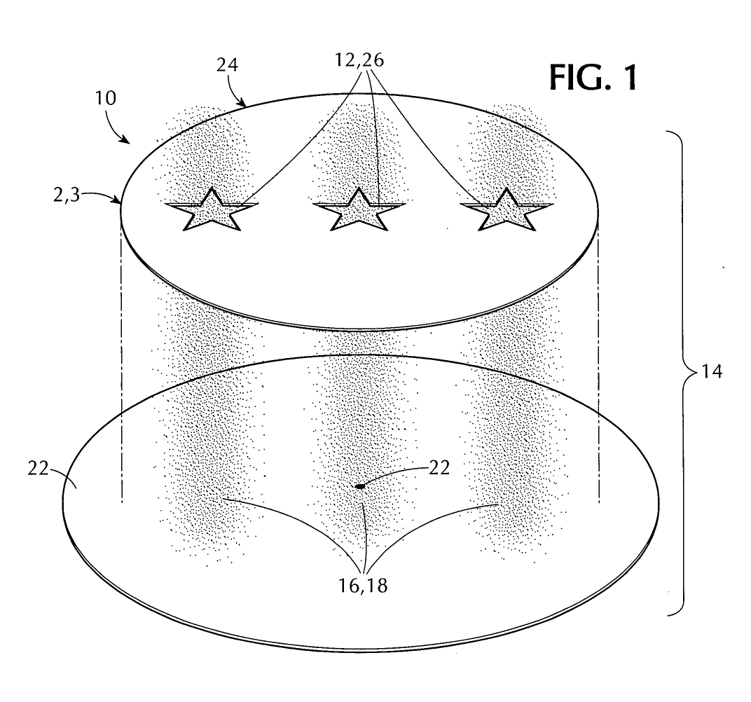

Referring now to the figures, in which like numerals indicate like parts, and particularly to FIG. 1, which is a diagrammatic exploded perspective view of the preformed topping disc of the embodiments of the present invention providing a predetermined image on a pizza pie when baked, the preformed topping disc of the embodiments of the present invention is shown generally at 10 for providing a predetermined image 12 on a pizza pie 14 generating vapor 16 and juice 18 when baked and having a center 20 and a periphery 22.

### B. Configuration of the Preformed Topping Disc 10

### (1) First Embodiment

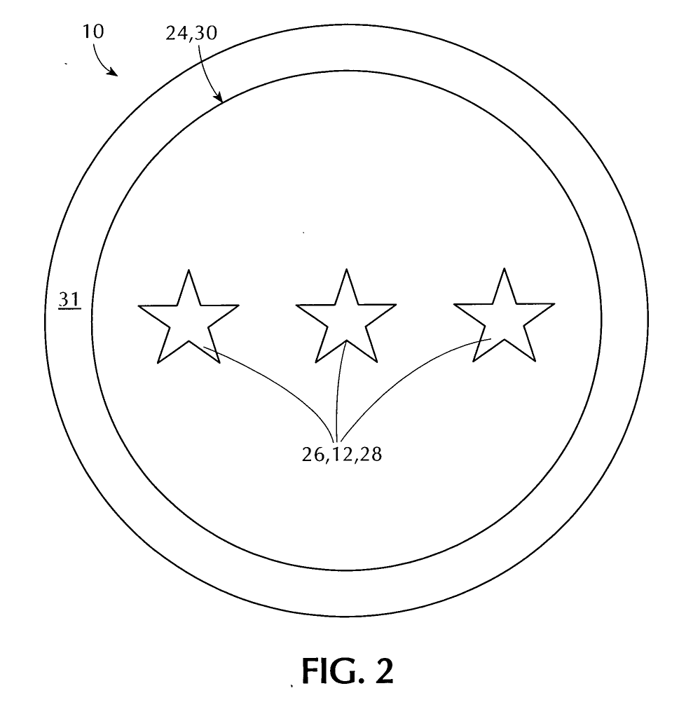

The configuration of a first embodiment of the preformed topping disc 10 can best be seen in FIG. 2, which is a diagrammatic top plan view of a one-piece topping disc of the embodiments of the present invention identified by ARROW 2 in FIG. 1, and as such, will be discussed with reference thereto.

The preformed topping disc 10 comprises a preformed cheese disc 24. The preformed cheese disc 24 contains specifically configured apertures 26 therethrough. The specifically configured apertures 26 in the preformed cheese disc 24 are for providing the predetermined image 12 on the pizza pie 14 by virtue of the vapor 16 and the juice 18 of the pizza pie 14 oozing through the specifically configured apertures 26 in the preformed cheese disc 24 when the pizza pie 14 is baked (FIG. 1).

The predetermined image 12 on the pizza pie 14 can be any desired image, for example, as shown in FIG. 2, stars 28, but is not limited to that, and can be a funny face, a logo, etc.

The preformed cheese disc 24 is dimensioned to extend from the center 20 of the pizza pie 14 into the peripheral region 22 of the pizza pie 14 in one continuous preformed cheese disc 30, but is not limited to that.

The preformed topping disc 10 further comprises a non-sticking membrane 31. The non-sticking membrane 31 separates a preformed cheese disc 24 from a next preformed cheese disc 24 so as to allow the preformed cheese discs 24 to be stacked without sticking to each other, while minimizing waste of cheese, providing a basis for checking how many pizza pies 14 have been baked, and preventing the preformed cheese disc 24 from drying out and picking up odors from the surrounding environment.

The non-sticking membrane 31 is larger than the preformed cheese disc 24 to facilitate removal, and is a sheet of wax paper.

### (2) Second Embodiment

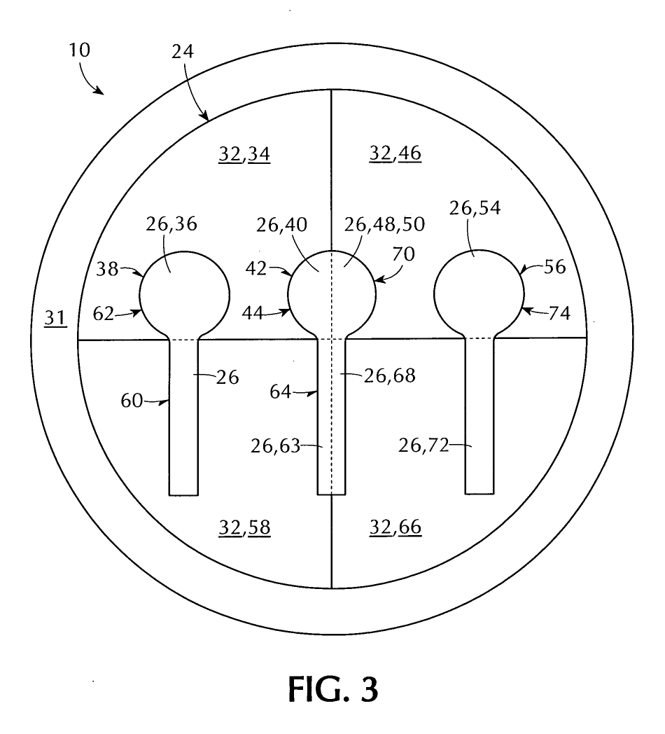

The configuration of a second embodiment of the preformed topping disc 10 can best be seen in FIG. 3, which is a diagrammatic top plan view of a multi-piece preformed topping disc of the embodiments of the present invention identified by ARROW 3 in FIG. 1, and as such, will be discussed with reference thereto.

The preformed cheese disc 24 of the second embodiment is similar to the preformed cheese disc 24 of the first embodiment, except that the preformed cheese disk 24 of the second embodiment is made up of multiple individual pieces 32 instead of one-piece as with the preformed cheese disc 24 of the first embodiment. Each individual piece 32 can contain different specifically configured apertures 26 so as to allow the predetermined image 12 on the pizza pie 14 to be truly customizable by merely mixing and matching the multiple individual pieces 32 of the preformed cheese disc 24. For example:

A first individual piece 34 of the multiple individual pieces 32 of the preformed cheese disc 24 contains the specifically configured apertures 26 that include a first full circle 36 to simulate a first complete lolly pop top 38 and a first half circle 40 to simulate a first half 42 of a second complete lolly pop top 44.

A second individual piece 46 of the multiple individual pieces 32 of the preformed cheese disc 24 contains the specifically configured apertures 26 that include a second half circle 48 to simulate a second half 50 of the second complete lolly pop top 44 and a second full circle 54 to simulate a third complete lolly pop top 56.

A third individual piece 58 of the multiple individual pieces 32 of the preformed cheese disc 24 contains the specifically configured apertures 26 that include a first complete lolly pop stick 60 that communicates with the first complete lolly pop top 38 so as to form a first complete lolly pop 62 and a first half 63 of a second lolly pop stick 64 that communicates with the first half 42 of the second complete lolly pop top 44.

A fourth individual piece 66 of the multiple individual pieces 32 of the preformed cheese disc 24 contains the specifically configured apertures 26 that include a second half 68 of the second lolly pop stick 64 that communicates with the first half 63 of the second lolly pop stick 64 and the second half 50 of the second complete lolly pop top 44 so as to form a second complete lolly pop 70 and a third complete lolly pop stick 72 that communicates with the third complete lolly pop top 56 so as to form a third complete lolly pop 74.

### C. Impressions

It will be understood that each of the elements described above or two or more together may also find a useful application in other types of constructions differing from the types described above.

While the embodiments of the present invention has been illustrated and described as embodied in a preformed topping disc for providing a predetermined image on a pizza pie when baked, however, it is not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A preformed topping disc for providing a predetermined image on a pizza pie when baked, wherein the pizza pie generates vapor and juice when baked, comprising:
a preformed cheese disc;
wherein said preformed cheese disc contains specifically configured apertures therethrough; and
wherein said specifically configured apertures in said preformed cheese disc are for providing the predetermined image on the pizza pie by virtue of the vapor and the juice of the pizza pie oozing through said specifically configured apertures in said preformed cheese disc when the pizza pie is baked.

2. The preformed topping disc of claim 1, wherein the pizza pie has a center;
wherein the pizza pie has a periphery; and
wherein said preformed cheese disc is dimensioned to extend from the center of the pizza pie into the peripheral region of the pizza pie.

3. The preformed topping disc of claim 1, wherein said preformed cheese disc is one continuous preformed cheese disc.

4. The preformed topping disc of claim 1, further comprising a non-sticking membrane; and
wherein said non-sticking membrane separates a preformed cheese disc from a next preformed cheese disc so as to allow said preformed cheese discs to be stacked without sticking to each other, while minimizing waste of cheese, providing a basis for checking how many pizza pies have been baked, and preventing said preformed cheese disc from drying out and picking up odors from a surrounding environment.

5. The preformed topping disc of claim 4, wherein said non-sticking membrane is larger than said preformed cheese disc to facilitate removal.

6. The preformed topping disc of claim 4, wherein said non-sticking membrane is a sheet of wax paper.

7. The preformed topping disc of claim 1, wherein said preformed cheese disc is made up of multiple individual pieces.

8. The preformed topping disc of claim 7, wherein each individual piece of said multiple individual pieces of said preformed cheese disc contains different specifically configured apertures so as to allow the predetermined image on the pizza pie to be truly customizable by merely mixing and matching said multiple individual pieces of said preformed cheese disc.
